(19) United States
(12) Patent Application Publication
(10) Pub. No.: US 2010/0299303 A1
(43) Pub. Date: Nov. 25, 2010

(54) Automatically Ranking Multimedia Objects Identified in Response to Search Queries

(75) Inventors: Eva Horster, Augsburg (DE); Malcolm Graham Slaney, Santa Clara, CA (US); Kilian Quirin Weinberger, Mountain View, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/470,437

(22) Filed: May 21, 2009

(51) Int. Cl. G06N 7/02; G06F 7/00; G06F 17/30

(52) U.S. Cl. 706/52; 703/13; 707/E17.014; 707/E17.018; 707/E17.101

(57) ABSTRACT

Construct a statistical model for a plurality of multimedia objects identified in response to a search query, the statistical model comprising a plurality of probabilities, wherein each of the multimedia objects uniquely corresponding to a different one of a plurality of sets of feature values, each of the feature values of each of the sets of feature values being a characterization of the multimedia object corresponding to the set of feature values, and each of the probabilities being calculated for a different one of the multimedia objects based on the set of feature values corresponding to the multimedia object. Rank the multimedia objects based on their corresponding probabilities, such that a multimedia object having a relatively higher probability is ranked relatively higher.

### TECHNICAL FIELD

The present disclosure generally relates to automatically ranking a set of multimedia objects identified in response to a search query.

### BACKGROUND

The Internet provides access to a vast amount of information. The information is stored at many different sites, e.g., on computers and servers and in databases, around the world. These different sites are communicatively linked to the Internet via various network infrastructures. People, i.e., Internet users, may access the publicly available information on the Internet via various suitable network devices connected to the Internet, such as, for example, computers and telecommunication devices.

Due to the sheer amount of information available on the Internet, it is impractical as well as impossible for an Internet user to manually search throughout the Internet for specific pieces of information. Instead, most Internet users rely on different types of computer-implemented tools to help them locate the desired information. One of the most convenient and widely used tools is a search engine, such as the search engines provided by Yahoo!® Inc. (http://search.yahoo.com), Google™ (http://www.google.com), and Microsoft® Inc. (http://search.live.com).

To search for the information relating to a specific topic or subject matter, an Internet user provides a short phrase consisting of one or more words, often referred to as a “search query”, to a search engine. The search query typically describes the topic or subject matter. The search engine conducts a search based on the search query using various search algorithms and generates a search result that identifies one or more contents most likely to be related to the topic or subject matter described by the search query. Contents are data or information available on the Internet and may be in various formats, such as texts, audios, videos, graphics, etc. The search result is then presented to the user requesting the search, often in the form of a list of clickable links, each link being associated with a different web page containing some of the contents identified in the search result. The user then is able to click on the individual links to view the specific contents as he wishes.

There are continuous efforts to improve the performance qualities of the search engines. Accuracy, completeness, presentation order, and speed are but a few aspects of the search engines for improvement.

### SUMMARY

The present disclosure generally relates to automatically ranking a set of multimedia objects identified in response to a search query.

In particular embodiments, a statistical model is constructed for a plurality of multimedia objects identified in response to a search query, the statistical model comprising a plurality of probabilities, wherein each of the multimedia objects uniquely corresponding to a different one of a plurality of sets of feature values, each of the feature values of each of the sets of feature values being a characterization of the multimedia object corresponding to the set of feature values, and each of the probabilities being calculated for a different one of the multimedia objects based on the set of feature values corresponding to the multimedia object. The multimedia objects are ranked based on their corresponding probabilities, such that a multimedia object having a relatively higher probability is ranked relatively higher.

These and other features, aspects, and advantages of the disclosure are described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 illustrates an example system for automatically ranking a set of multimedia objects identified in response to a search query.

FIG. 2 illustrates an example method for automatically ranking a set of multimedia objects identified in response to a search query.

FIG. 3 illustrates an example computer system.

### DETAILED DESCRIPTION OF EXEMPLARY EMBODIMENTS

The present disclosure is now described in detail with reference to a few exemplary embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps or structures have not been described in detail in order to not unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Search engines help Internet users locate specific contents, i.e., data or information available on the Internet, from the vast amount of contents publicly available on the Internet. In a typical scenario, to locate contents relating to a specific topic or subject matter, an Internet user requests a search from a search engine by providing a search query to the search engine. The search query generally contains one or more words that describe the subject matter or the type of content or information the user is looking for on the Internet.

The search engine conducts the search based on the search query using various search algorithms employed by the search engine and generates a search result that identifies one or more specific contents that are most likely to be related to the search query. The contents identified in the search result are presented to the user, often as clickable links to various web pages located at various websites, each of the web pages containing some of the identified contents.

In addition to merely locating and identifying the specific contents relating to the individual search queries, the search engines often provide additional information that may be helpful to the users requesting the searches. For example, a search result generated in response to a search query most likely identifies multiple contents. A search engine may employ a ranking algorithm to rank the contents identified in a search result according to their degrees of relevance to the corresponding search query. Those contents that are relatively more relevant to the corresponding search query are ranked higher and presented to the user requesting the search before those contents that are relatively less relevant to the corresponding search query. Usually, the ranking algorithms are based on the links to the web pages identified by the search engines. For example, the PageRank algorithm, the HITS algorithm, the ranking algorithm developed by the IBM CLEVER project, and the TrustRank algorithm are some of the link-based ranking algorithms implemented by the various search engines. The PageRank algorithm and some of its applications are described in more detail in “Pagerank for product image search” by Y. Jing and S. Baluja, WWW '08: Proceeding of the 17th international conference on World Wide Web, pages 307-361.

There are continuous efforts to improve the performance qualities of the search engines. In particular embodiments, it may be desirable to employ different ranking algorithms to rank different types or categories of contents. For example, the link-based algorithms may not always be suitable for ranking the multimedia contents, as the multimedia contents do not always have corresponding links. Therefore, it may be desirable to develop alternative ranking methods or algorithms that are especially suited for ranking the multimedia contents. Textual contents are no longer the only type of contents available on the Internet. With the advent of digital media technologies, multimedia contents, such as audio contents, video contents, and graphic contents, are becoming increasingly popular and growing rapidly in size on the Internet. Websites such as YouTube™, Flickr®, iTunes, and Rhapsody™ provide great selections of multimedia contents. Consequently, Internet users frequently request search engines to locate specific multimedia contents. Some search engines provide special services that help users locate specific multimedia contents more easily on the Internet. For example, to search for specific images, a user may use Yahoo!® image search engine (http://images.search.yahoo.com) or Google™ image search engine (http://images.google.com), and to search for specific videos, a user may use Yahoo!® video search engine (http://video.search.yahoo.com) or Google™ video search engine (http://video.google.com). If a user provides a search query to an image search engine, only images are identified in the search result generated in response to the search query. Similarly, if a user provides a search query to a video search engine, only videos are identified in the search result generated in response to the search query. Thus, the special types of search engines focus the searches on the specific types of contents the users search for and only identify the particular types of contents the users request in the search results.

Linked-based ranking algorithms may not be best suited for ranking multimedia contents. Often, unlike web pages, multimedia contents do not have corresponding links. On the other hand, any content, whether multimedia or textual, may have one or more features. In particular embodiments, a feature represents a characteristic of a content. For example, each news article posted on the Internet may have a headline and a timestamp. The headline is the title of the news article and the timestamp indicates the time the news article is last updated. Thus, this particular type of contents, i.e., the news articles, has at least two features: headline and timestamp. Suppose a first news article's headline is “WHO reports 2500 cases of swine flue” and the first news article's timestamp is “May 8, 2009, 13:15 EDT”. Then, for the first news article, the value of the headline feature is “WHO reports 2500 cases of swine flue” and the value of the timestamp feature is “May 8, 2009, 13:15 EDT”. Suppose a second news article's headline is “official who OK'd Air Force One jet flyover resigns” and the second news article's timestamp is “May 8, 2009, 21:07 EDT”. Then, for the second news article, the value of the headline feature is “official who OK'd Air Force One jet flyover resigns” and the value of the time stamp feature is “May 8, 2009, 21:07 EDT”.

As the above example illustrates, an content may have one or more features and each feature may have a feature value specifically determined for the content. In the above example, both the first news article and the second news article have the same headline feature, but the feature values for the headline feature differ between the first news article and the second news article. Thus, in particular embodiments, a feature value is a characterization of a specific content with respect to a corresponding feature. An content may have one or more features, and for each feature, there may be a corresponding feature value. Multiple contents may share a same feature, but each of the contents may have a different feature value corresponding to the feature. And different contents may have different features with different feature values.

The multimedia contents, as a specific category of the contents, may have features that may not be available with other types of contents. For example and without limitation, a multimedia content may have one or more audio features, one or more visual features, one or more textual features, one or more geographical features, one or more temporal features, and one or more meta-features. Again, each of these features may have a feature value specifically determined for the individual multimedia content.

The audio features characterizing a multimedia content may include, for example and without limitation, the dynamic range (db) and the frequency of the sound, the format of the encoding, the bit rate of the encoding, the zero-crossing rating, and the variance of the spectral centroid. The visual features characterizing a multimedia content may include, for example and without limitation, an object or a part of an object shown in the image, the size of the object, the resolution, the dimension, the color histogram, the contrast, the brightness, the encoding/decoding algorithm, the frame rate, the camera angle, the number of shots in the video, the salient image features (SIFT), and texture matrices. The textual features characterizing a multimedia content may include, for example and without limitation, the tags assigned to the multimedia content, and features provided by latent-dirichlet analysis (LDA) and latent-semantic analysis (LSA). The geographical features characterizing a multimedia content may include, for example and without limitation, the location where the multimedia content is created, the location depicted by the multimedia content, the latitude, and the longitude. The temporal features characterizing a multimedia content may include, for example and without limitation, the time the multimedia content is created, the time the multimedia content is last modified, the time the multimedia content becomes available on the Internet, and the time of the day, the day of the week, the day of the month, or the day of the year when a photograph is taken.

A search engine may be able to take advantage of the fact that the multimedia contents have many different features, some of which are relatively unique to this category of the contents. In particular embodiments, a ranking algorithm based on the features and the corresponding feature values of the multimedia contents may be employed to rank a set of multimedia contents identified in response to a particular search query. The ranking algorithm may be employed by an Internet search engine for ranking multimedia contents located on the Internet or a database search application for ranking multimedia contents located in a database in response to a search query provided to the database search application. In fact, the ranking algorithm may be used to rank a set of multimedia contents identified in response to a search query in any type of search applications. Multimedia contents may include, for example, images, audios, videos, etc. Thus, a multimedia content may also be referred to as a multimedia object. Consequently, a set of multimedia contents may also be referred to as a set of multimedia objects. Within the context of the present disclosure, a multimedia content and a multimedia object may be used interchangeably. In particular embodiments, a set of multimedia contents or multimedia objects identified in response to a search query contains two or more multimedia contents or multimedia objects.

In particular embodiments, for a set of multimedia objects identified in response to a search query, a statistical model may be constructed. In particular embodiments, the statistical model contains a set of probabilities corresponding to the set of multimedia objects, with each of the probabilities uniquely corresponding to a different one of the multimedia objects. Thus, there is a one-to-one correspondency between a particular one of the probabilities and a particular one of the multimedia objects. Within the context of the present disclosure, let {O₁ . . . Oₘ} denote a set of multimedia objects having a total of m multimedia objects with m representing an integer greater than or equal to 2 and Oᵢ denoting a particular one of the multimedia objects in the set of multimedia objects; and let P(Oᵢ) denote the particular probability in the set of probabilities corresponding to the particular multimedia object denoted by Oᵢ Note that {O₁ . . . Oₘ} is the set of multimedia objects identified in response to a particular search query. Then, the statistical model contains the set of probabilities {P(O₁) . . . P(Oₘ)} with m denoting the total number of probabilities in the set of probabilities corresponding to the set of multimedia objects. The set of multimedia objects may be ranked based on their corresponding probabilities, such that a multimedia object with a relatively higher probability is ranked higher and a multimedia object with a relatively lower probability is ranked lower within the set of multimedia objects. Therefore, the ranking scheme suggests that a multimedia object with a relatively higher probability from the set of multimedia objects is relatively more relevant to the corresponding search query than a multimedia object with a relatively lower probability from the same set of multimedia objects.

In particular embodiments, a set of features is determined or selected for a particular set of multimedia objects. That is, each set of multimedia objects has a corresponding set of features. To determine the feature values for each of the individual multimedia objects belonging to the same set of multimedia objects, the feature values are determined with respect to the same set of features corresponding to the set of multimedia objects. Sometimes, a particular multimedia object may not have some of the features included in the corresponding set of features. In particular embodiments, if a particular multimedia object does not have some of the features included in the corresponding set of features, the feature values for those features are set to O. For example, videos typically have both audio and visual features. As a result, a set of features determined for a set of video objects typically include both audio and visual features. However, a particular video object in the set of video objects may not have any sound. Thus, this particular video object may not have some of the audio features. In this case, all the feature values corresponding to those audio features may be set to 0 for the particular video object. Other feature values may be used to represent a lack of a particular feature for a multimedia object in different embodiments. Sometimes, multiple multimedia objects may have the same feature value with respect to a particular feature. For example, if two images have the same resolution of one million pixels, the feature values with respect to the resolution feature for both of the images are one million pixels.

In particular embodiments, a set of features may contain one or more features. Sometimes, the same set of features may be applied to multiple sets of multimedia objects identified in different search results. Other times, different sets of features may be determined for different sets of multimedia objects identified in different search results. In particular embodiments, for each set of multimedia object identified in response to a particular search query, the corresponding set of features may be user-determined or determined based on experimental or empirical data.

For example, a search engine may receive multiple search queries requesting video objects relating to a particular subject matter. In response, the search engine may generate multiple search results, each search result identifying a different set of video objects. Since all of the video objects in the multiple sets of video objects relate to the same subject matter and thus probably have similar features, a set of features may be determined for and applied to all of the sets of video objects. However, each video object may have different feature values with respect to the individual features. On the other hand, multiple sets of multimedia objects relating to different subject matters may not share similar features, in which case it may be more appropriate to determine different sets of features for the different sets of multimedia objects.

In particular embodiments, different sets of features may be selected for different types of multimedia objects so that each set of features includes, among others, particular features suitable or appropriate for the type of multimedia objects to which it is applied. For example, for sets of audio objects, the set of features selected may include various audio features but may not include any visual features since audio objects normally do not have any images. On the other hand, for sets of graphic objects, the set of features selected may include various visual features but may not include any audio features since graphic objects normally do not have any sounds. However, for sets of video objects, the set of features selected may include both audio features and visual features since video objects normally include both images and sounds. Of course, the sets of feature may also include those features that are common among many types of the multimedia objects.

To summarize, in particular embodiments, with respect to a single set of multimedia objects identified in response to a search query, there is a corresponding set of probabilities and a corresponding set of features. Each of the probabilities is calculated for a different one of the multimedia objects based on the set of feature values corresponding to that multimedia object. With respect to each individual multimedia object in the set, there is a corresponding probability and a corresponding set of feature values, and each of the feature values is specifically determined for the multimedia object with respect to a different one of the features in the same corresponding set of features. Thus, with respect to each individual multimedia object, there is a one-to-one correspondency between a particular one of the feature values and a particular one of the features.

Within the context of the present disclosure, let {F¹ . . . Fⁿ} denote a set of features having a total of n features with n representing an integer greater than or equal to 1 and F^{j} denoting a particular feature in the set of features; and let {fᵢ¹ . . . fᵢⁿ} denote a set of feature values associated with the particular multimedia object denoted by Oᵢ and corresponding to the set of features denoted by {F¹ . . . Fⁿ} with fᵢ^{j} denoting the value of the particular feature denoted by F^{j} for the particular multimedia object denoted by Oᵢ. The following Table 1 illustrates the relationships between multimedia objects, probabilities, features, and feature values for a set of multimedia objects.

TABLE 1
Relationships between Multimedia Objects, Probabilities,
Features, and Feature Values

| | | Feature Values |
|---|---|---|
| | | Corresponding |
| | | to the Set of |
| Multimedia | | Features Denoted |
| Objects | Probabilities | by {F¹ . . . Fⁿ} |
| O₁ | P(O₁) | {f₁¹ . . . f₁ⁿ} |
| O₂ | P(O₂) | {f₂¹ . . . f₂ⁿ} |
| . . . | . . . | . . . |
| Oₘ | P(Oₘ) | {fₘ¹ . . . fₘⁿ} |

In particular embodiments, for each multimedia object in the set of multimedia objects, its corresponding probability is calculated based on its corresponding set of feature values. More specifically, for a particular multimedia object denoted by Oᵢ, its corresponding probability denoted by P(Oᵢ) may be calculated based on its corresponding set of feature values denoted by {fᵢ¹ . . . fᵢⁿ}. In particular embodiments, for a particular multimedia object denoted by Qᵢ, its corresponding probability denoted by P(Oᵢ) may be calculated as:

P(Oᵢ)=P(fᵢ¹, fᵢ², . . . , fᵢⁿ) (1)

That is, the probability denoted by P(Oᵢ) equals the probability of the conjunction of the feature values in the corresponding set of feature values denoted by {fᵢ¹ . . . fᵢⁿ}.

In particular embodiments, with respect to a set of multimedia objects, the multimedia objects may be ranked based on their corresponding probabilities, such that a multimedia object having a relatively higher probability is ranked relatively higher and a multimedia object having a relatively lower probability is ranked relatively lower. In particular embodiments, for ranking purposes, the probability of each of the multimedia objects in a set of multimedia objects may be calculated using Equation (1).

In general, when ranking a set of objects identified in a search result generated in response to a search query, it is desirable that those objects that are relatively more relevant to the search query are ranked higher than those objects that are relatively less relevant to the search query. The relatively higher-ranked objects may then be presented to the user requesting the search before the relatively lower-ranked objects. The same concept applies to ranking a set of multimedia objects for search purposes.

The statistical model, {P(O₁) . . . P(Oₘ)}, used for ranking a set of multimedia objects generated in response to a search query is based on the hypothesis that a representative multimedia object is the multimedia object more likely to be related to the search query. The more representative the multimedia object, the more relevant the multimedia object is to the search query. In particular embodiments, the most representative multimedia objects among the set of multimedia objects may be found by looking for the peaks in a probabilistic model. Thus, the statistical model contains the probabilities for all the multimedia objects belonging to a set of multimedia objects identified in response to a search query. The probability calculated for each of the multimedia objects indicates how representative, i.e., the degree of representativeness, that particular multimedia object is to the search query.

Experimental data suggest that the statistical model works better with large sets of multimedia objects having large sets of feature values. In such cases, the large amount of data help find correlations between multiple features among the multimedia objects within the same set of multimedia objects. However, for a large set of multimedia objects each having a large set of feature values, it may be prohibitively expensive to compute a joint distribution for all of the feature values as defined by Equation (1). Instead, in particular embodiments, the statistical model may be divided into smaller sub-models because it may be assumed that each feature value is statistically independent of the other feature values. Thus, Equation (1) may be approximated as:

$$P ( {O}_{i} ) ∝ {\prod }_{j = 1}^{j = n} {[ P ( {f}_{i}^{j} ) ]}^{{α}_{j}} \qquad ( 2 )$$

where P(fᵢ^{j}) denotes the probability of a particular feature value denoted by fᵢ^{j} and αⱼ denotes a weight assigned to the probability denoted by P(fᵢ^{j}). In particular embodiments, αⱼ may be a value between 0 and 10. In particular embodiments, the individual weights may be user-selected or determined based on empirical or experimental data. For example, the upper limit for αⱼ may be different values for different implementations. If the importance of all of the individual feature values is the same, αⱼ may be set to 1 for all of the probabilities denoted by P(fᵢ^{j}).

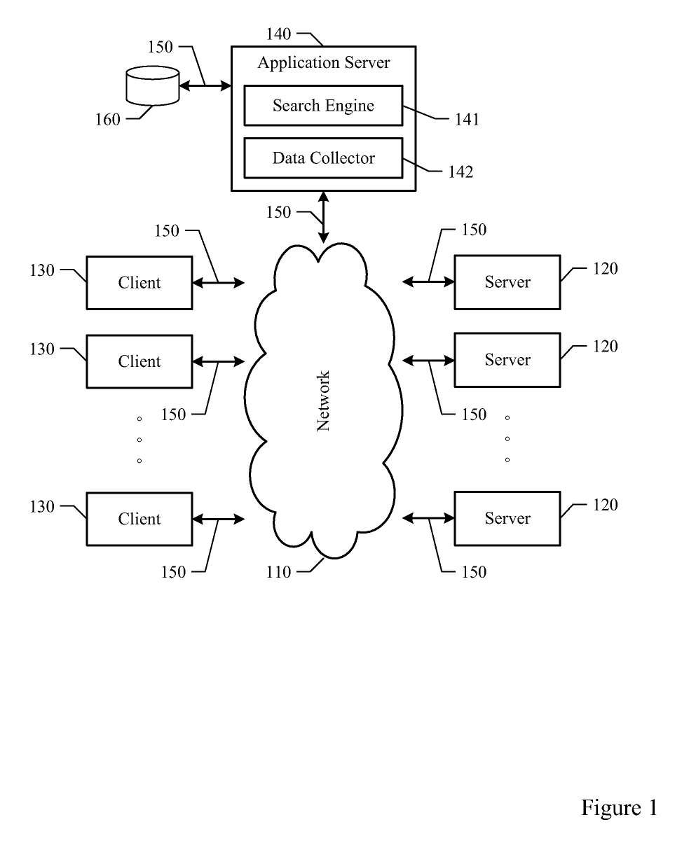

FIG. 1 illustrates an example system 100 for automatically ranking a set of multimedia objects identified in response to a search query. System 100 includes a network 110 coupling one or more servers 120, one or more clients 130, and an application server 140 to each other. In particular embodiments, network 110 is an intranet, an extranet, a virtual private network (VPN), a local area network (LAN), a wireless LAN (WLAN), a wide area network (WAN), a metropolitan area network (MAN), a portion of the Internet, or another network 110 or a combination of two or more such networks 110. The present disclosure contemplates any suitable network 110.

One or more links 150 couple a server 120, a client 130, or application server 140 to network 110. In particular embodiments, one or more links 150 each includes one or more wired, wireless, or optical links 150. In particular embodiments, one or more links 150 each includes an intranet, an extranet, a VPN, a LAN, a WLAN, a WAN, a MAN, a portion of the Internet, or another link 150 or a combination of two or more such links 150. The present disclosure contemplates any suitable links 150 coupling servers 120, clients 130, and application server 140 to network 110.

In particular embodiments, each server 120 may be a unitary server or may be a distributed server spanning multiple computers or multiple datacenters. Servers 120 may be of various types, such as, for example and not by way of limitation, web server, news server, mail server, message server, advertising server, file server, application server, exchange server, database server, or proxy server. In particular embodiments, each server 120 includes hardware, software, or embedded logic components or a combination of two or more such components for carrying out the appropriate functionalities implemented or supported by server 120. For example, a web server is generally capable of hosting websites containing web pages or particular elements of web pages. More specifically, a web server may host HTML files or other file types, or may dynamically create or constitute files upon a request, and communicate them to clients 130 in response to HTTP or other requests from clients 130. A mail server is generally capable of providing electronic mail services.

In particular embodiments, a client 130 enables a user at client 130 to access network 110. As an example and not by way of limitation, a client 130 may be a desktop computer system, a notebook computer system, a netbook computer system, or a mobile telephone having a web browser, such as Microsoft Internet Explore, or Mozilla Firefox, which, for example, may have one or more add-ons, plug-ins, or other extensions, such as Google Toolbar or Yahoo Toolbar. The present disclosure contemplates any suitable clients 130.

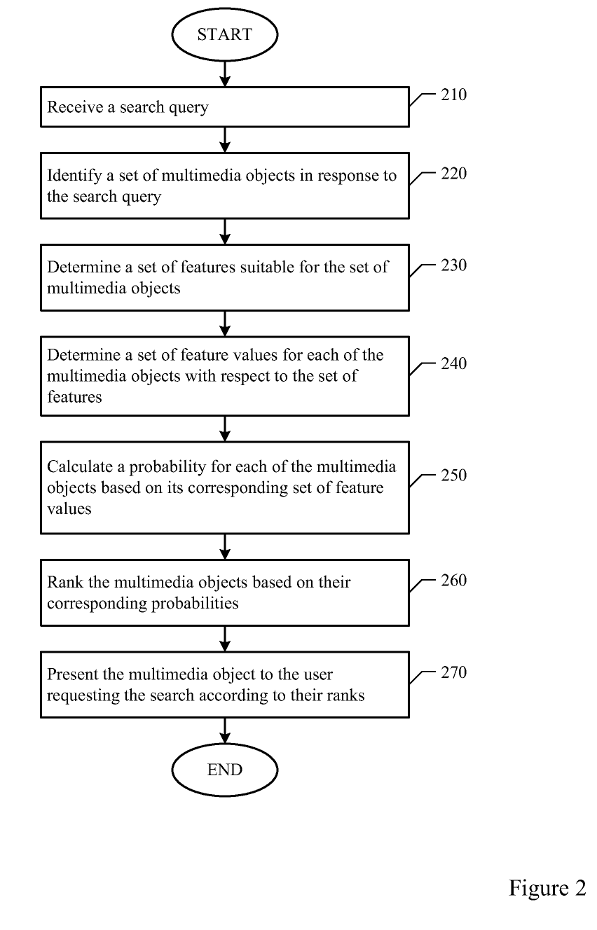

In particular embodiments, application server 140 includes one or more computer servers or other computer systems, either centrally located or distributed among multiple locations. In particular embodiments, application server 140 includes hardware, software, or embedded logic components or a combination of two or more such components for carrying out various appropriate functionalities. Some of the functionalities performed by application server 140 are described in more detail below with reference to FIG. 2.

In particular embodiments, application server 140 includes a search engine 141. In particular embodiments, search engine 141 includes hardware, software, or embedded logic component or a combination of two or more such components for generating and returning search results identifying contents responsive to search queries received from clients 130. The present disclosure contemplates any suitable search engine 141. As an example and not by way of limitation, search engine 141 may be Altavist™, Baidu, Google, Windows Live Search, or Yahoo!® Search. In particular embodiments, search engine 141 may implement various search, ranking, and summarization algorithms. The search algorithms may be used to locate specific contents for specific search queries. The ranking algorithms may be used to rank a set of contents located for a particular search query. The summarization algorithms may be used to summarize individual contents. In particular embodiments, one of the ranking algorithms employed by search engine 141 may be implemented based on the statistical model described above and search engine 141 may use this particular ranking algorithm to rank sets of multimedia objects located in response to particular search queries.

In particular embodiments, application server 140 includes a data collector 142. In particular embodiments, data collector 142 includes hardware, software, or embedded logic component or a combination of two or more such components for monitoring and collecting network traffic data at search engine 141. In particular embodiments, the network traffic data collected include at least the search queries received at search engine 141. In addition, the network traffic data collected may also include, for example, the time each of the search queries is received at search engine 141, the search results generated by search engine 141 in response to the search queries, and the types of the individual contents identified in each of the search results. A data storage 160 is communicatively linked to application sever 140 via a link 150 and may be used to store the collected network traffic data at search engine 141 for further analysis.

As explained above, the ranking algorithm may be used by any type of search applications for ranking a set of multimedia objects identified in response to a search query, e.g., on the Internet or in databases. Thus, the Internet is not necessary. For example, a standalone database server or client may implement the ranking algorithm.

FIG. 2 illustrates an exemplary method for automatically ranking a set of multimedia objects identified in response to a search query. In particular embodiments, upon receiving a search query (step 210), a search application, e.g., a search engine, identifies a set of multimedia objects in response to the search query (step 220). The multimedia objects may, for example, be audio objects, video objects, or graphic objects. The set of multimedia objects may be the candidate objects for the search result that eventually is generated for the search query, and some or all of the multimedia objects from the set may be included in the search result.

In particular embodiments, a set of features suitable for the set of multimedia objects may be determined (step 220). Each of the features is a characterization of the multimedia objects. The set of features may be user-determined or may be determined based on empirical or experimental data.

For each of the multimedia objects in the set of multimedia objects, determine a set of feature values with respect to the set of features, each of the feature values uniquely corresponding to a different one of the features (step 240). For a particular multimedia object, a particular corresponding feature value characterizes the multimedia object with respect to the particular corresponding feature. For example, consider a set of graphic objects that includes three images, denoted by O₁, O₂, and O₃. Note that images are one type of multimedia objects. The same concept applies similarly to all types of multimedia objects, e.g., audio objects, video objects, or graphic objects. Furthermore, the example set of graphic objects only has three images for illustrative purposes only. In practice, there is no limitation to the number of multimedia contents or objects that may be included in a set. In fact, experimental data suggest that the statistical model produces better results when working with relatively large sets of multimedia contents or objects.

Suppose a set of suitable features has been determined that characterizes the set of graphic objects. The set of features includes five individual features, denoted by F¹, F², F³, F⁴, and F⁵. F¹ represents the number of red pixels in an image; F² represents the number of green pixels in an image; and F³ represents the number of blue pixels in an image. Since these three features characterize visual information of the images, they may be considered as visual features. F⁴ represents the title of an image, and may be considered a textual feature. F⁵ represents the time the image is first created, and may be considered a temporal feature.

For O₁, a set of feature values may be determined, including f₁¹, f₁², f₁³, f₁⁴, and f₁⁵. If O₁ has a total of 250 red pixels, 180 green pixels, and 300 blue pixels, then f₁¹ equals 250, f₁³ equals 180, and f₁³ equals 300. If the title given to O₁ is “the Golden Gate Bridge”, then f₁⁴ equals “the Golden Gate Bridge”. If O₁ is a digital photograph taken on May 7, 2009 at 10:00 EDT, then f₁⁵ equals “2009-05-07 10:00 EDT”.

Similarly, for O₂, a set of feature values may be determined, including f₂¹, f₂², f₂³, f₂⁴, and f₂⁵, with f₂¹ being equal to the total number of red pixels in O₂, f₂² being equal to the total number of blue pixels in O₂, f₂³ being equal to the total number of blue pixels in O₂, f₂⁴ being equal to the title given to O₂, and f₂⁵ being equal to the time when O₂ is originally created. For O₃, a set of feature values may be determined, including f₃¹, f₃², f₃³, f₃⁴, and f₃⁵. Sometimes, some of the feature values may be the same for two or more of the multimedia objects belonging to the same set with respect to a particular feature. For example, all three images may have the same title, “the Golden Gate Bridge”, in which case f₁⁴, f₂⁴, and f₃⁴ all equal “the Golden Gate Bridge”.

For each of the multimedia objects in the set of multimedia objects, calculate a different probability based on the set of feature values corresponding to the multimedia object (step 250). Again, using the example set of graphic objects that includes O₁, O₂, and O₃, a probability, denoted by P(O₁), may be calculated for O₁ based on {f₁¹,f₁², f₁³, f₁⁴, f₁⁵}; a probability, denoted by P(O₂), may be calculated for O₂ based on {f₂¹, f₂², f₂³, f₂⁴, f₂⁵}; and a probability, denoted by P(O₃), may be calculated for O₃ based on {f₃¹, f₃², f₃³, f₃⁴, f₃⁵}. The following Table 2 illustrates the relationships between the example set of graphic objects, the corresponding set of probabilities, the example set of features, and the corresponding sets of feature values.

TABLE 2

| | | Feature Values |
|---|---|---|
| | | Corresponding |
| | | to the Set of |
| Graphic | | Features Denoted by |
| Objects | Probabilities | {F¹ F² F³ F⁴ F⁵} |
| O₁ | P(O₁) | {f₁¹, f₁², f₁³, f₁⁴, f₁⁵} |
| O₂ | P(O₂) | {f₂¹, f₂², f₂³, f₂⁴, f₂⁵} |
| O₃ | P(O₃) | {f₃¹, f₃², f₃³, f₃⁴, f₃⁵} |

In particular embodiments, each of the probabilities may be calculated for each of the corresponding multimedia objects using Equation (2). For example, for O₁,

$$P ( {O}_{1} ) = {\prod }_{j = 1}^{j = 5} {[ P ( {f}_{1}^{j} ) ]}^{{α}_{j}} , for {O}_{2} , P ( {O}_{2} ) = {\prod }_{j = 1}^{j = 5} {[ P ( {f}_{2}^{j} ) ]}^{{α}_{j}} , \\ and for {O}_{3} , P ( {O}_{3} ) = {\prod }_{j = 1}^{j = 5} {[ P ( {f}_{3}^{j} ) ]}^{{α}_{j}} .$$

In equation (2), P(fᵢ^{j}) denotes the probability of a particular feature value denoted by fᵢ^{j}. As explained above, there may be different types of features, such as, for example, audio features, visual features, textual features, geographic features, and temporal features. In particular embodiments, the probability of each type of feature values or of each individual feature value may be calculated using different statistical sub-models. The statistical sub-models may be user-determined or selected based on the nature of the features, experimental or empirical data, or any other suitable information.

One category of the features may be visual features. In particular embodiments, each visual feature characterizes a visual aspect of the multimedia objects, such as, for example, object in the image or its shape, color distribution, brightness, contrast, distinct areas, background noise, etc. In particular embodiments, locally shift-invariant, sparse representations, which are learned, may be used to build the statistical sub-models for calculating the probabilities of the visual feature values for a multimedia object. The ability to learn representations that are both sparse and locally shift-invariant may be desirable for the purpose of the statistical sub-models because the exact location of the objects in the graphic portion of the multimedia objects, i.e., the images, is relatively unimportant. The learning of the locally shift-invariant, sparse representations is discussed in more detail in “Unsupervised learning of invariant feature hierarchies with applications to object recognition” by M. Ranzato, F. J. Huang, Y. L. Boureau, and Y. LeCun, Computer Vision and Pattern Recognition, June 2007, pages 1-8.

In particular embodiments, existing sparse coding models may be employed. For example, one well-known sparse coding model is defined as the following. Note that since the visual features are generally found in the graphic portion of the multimedia objects, the following discussion on the particular statistical sub-model for the probabilities of the visual features refer to the multimedia objects as images.

Given a vectorized input image patch IεR^{M}, seek the code ZεR^{N}, with possibly N>M, that may reconstruct the input image, the code is sparse and minimizes the following objective function:

$$L ( I , Z ; {W}_{d} ) = {‖ I - {W}_{d} Z ‖}^{2} + λ {\sum }_{k} \vert {Z}_{k} \vert \qquad ( 3 )$$

where W_{d}εR^{M×N} denotes a matrix to be learned, and λεR⁺ denotes a hyperparameter controlling the sparsity of the representation. In particular embodiments, the matrix W_{d} is learned with an online block-coordinate gradient-descent algorithm. Given a training-image patch, (1) minimize the loss in Equation (3) with respect to Z to produce the optimal sparse code, and (2) update the parameters W_{d} by one step of gradient descent using the optimal sparse code and normalize the columns of W_{d} to 1. The re-normalization may be necessary since the loss is trivially decreased by multiplying and dividing W_{d} and Z by the same factor. When applying this algorithm to natural images it learns features that resemble Gabor wavelets. However, in particular embodiments, this code may be too expensive to be used in practical situations. Computing the sparse code corresponding to an input image patch requires solving a convex but non-quadratic optimization problem. Although many optimization algorithms have been proposed in the literature, the iterative procedure may be prohibitively expensive when encoding whole images in large-scale web applications.

To address this problem, in particular embodiments, a feed-forward approximation is employed. A feed-forward regressor may be trained to directly map input image patches to sparse codes. Consider the class of D tan h(Wₑ I) functions, where tan h denotes the hyperbolic tangent non-linearity, D denotes a diagonal matrix of coefficients, and Wₑ denotes a M×N matrix. Training the feed-forward regressor consists of minimizing the squared reconstruction error between the output of the function D tan h(Wₑ I) and the optimal sparse codes with respect to the parameters Wₑ and D. The optimization may be performed after optimizing Wₑ, or jointly by adding this extra error term to the loss of Equation (3) as:

$$L ( I , Z ; {W}_{d} , D , {W}_{e} ) = {‖ I - {W}_{d} Z ‖}^{2} + λ {\sum }_{k} \vert {Z}_{k} \vert + {‖ Z - D tanh ( {W}_{e} I ) ‖}^{2} \qquad ( 4 )$$

Since the joint optimization is faster because the inference step enjoys the initialization provided by the feed-forward regressor, in particular embodiments, it is chosen as the optimization strategy. The training algorithm is the very same one, alternating a minimization over Z and a parameter update step over (W_{d}, Wₑ, D). Note that the rows of matrix Wₑ may be interpreted as trainable filters that are applied to the input images.

In order to make the codes not only sparse but also translation invariant over small spatial neighborhoods, in particular embodiments, this algorithm may be extended by using the filters convolutionally over the input image patch, which is not vectorized and whose spatial resolution is larger than the support of the filters, and to take the maximum across non-overlapping windows. The resulting code becomes invariant to translations within the corresponding window. The reconstruction is similar as before, but done convolutionally as well. First, the code units are placed in the feature maps at the locations where the maxima where found, and then the resulting feature maps are convolved with the reconstruction filters and summed up to produce the reconstruction of the input images.

The learning algorithm remains unchanged when adding a spatially invariant aspect to the sparse code because both algorithms reconstruct the input images while satisfying a sparsity constraint. In particular embodiments, these algorithms do not make any specific assumption on the input images. Therefore, it may be replicated to build a feature hierarchy, analogous to the training scheme employed in deep learning methods. The algorithm is first trained using image patches. Once the filter banks are learned via algorithm training, the feed-forward mapping function is used to directly predict approximately sparse and locally shift-invariant codes to train another layer. The same greedy process may be repeated for as many layers as desired. The resulting features are sparse and locally shift-invariant, and are produced by a simple feed-forward pass through a few stages of convolution and max-pooling.

Another category of the features may be textual features. The feature values of the textual features for particular multimedia objects may be obtained, for example, from the tags associated with the individual multimedia objects. A tag is a string associated with a multimedia object and usually describes the subject matter or provides other types of metadata for the multimedia object. For example, MP3 audio files are often associated with tags such as “artist”, “album title”, “track title”, “genre”, “duration”, “bit rate”, etc. Image and video files are often associated with tags such as “title”, “duration”, “subject matter”, “description”, etc. Each textual feature may be a characterization of a tag assigned to the multimedia objects.

Similarly, in particular embodiments, a combination of a bag of words description, which characterizes the number of times each word is in the description of the multimedia objects, and a deep network may be used as the statistic sub-model for calculating the probabilities of the textual feature values for a multimedia object. In particular embodiments, the deep network may use multiple, non-linear hidden layers and was first introduced in the context of modeling image patches and text documents. This deep network computes, similar to the model for visual features described above, a low-dimensional representation from which the tags associated with a multimedia object may be reconstructed with low-error.

In particular embodiments, the learning procedure for such a deep model consists of two stages. In the first stage, the pre-training, an initialization is computed based on restricted Boltzmann machines (RBM). The second stage refines the representation by using back-propagation.

RBMs provide a simple way to learn a single layer of hidden features without supervision. They consist of a layer of visible units that are connected to hidden units using symmetrically weighted connections. Note that a RBM does not have any visible-visible or hidden-hidden connections. One step contrastive divergence may be applied to learn the variables of a RBM, i.e. its weights and biases.

To extend this concept and construct a deep network, additional layers of features may be learned by treating the hidden states or activation probabilities of the lower-level RBM as the visible data for training a higher-level RBM that learns the next layer of features. Note that in particular embodiments, the learning algorithm for visual features e.g., based on pixels, described above uses a similar approach for learning a feature hierarchy. Here the outcome of a lower layer may also be used as the input to learn another feature layer. By repeating this greedy layer-by-layer training several times, a deep model is learned that is able to capture higher-order correlations between the input units. The semantic deep network model is discussed in more detail in “Semantic hashing” by R. R. Salakhutdinov and G. E. Hinton, Proceedings of SIGIR Workshop on Information Retrieval and Applications of Graphical Models, 2007.

After pre-training all layers, the parameters of the deep model may be further refined. In particular embodiments, the refinement is done by replacing the stochastic activations of the binary features with deterministic real-valued probabilities and unrolling the layers to create an auto-encoder, as discussed in more detail in “Reducing the dimensionality of data with neutral networks” by G. E. Hinton and R. R. Salakhutdinov, Science, 2006, pages 504-507. Using the pre-trained biases and weights to initialize the back-propagation algorithm, back-propagation may be used to fine-tune the parameters for optimal reconstruction of the input data.

In particular embodiments, the input vector from tags to such a deep network is a word count vector that is in general not binary. First, divide each entry of the respective vector by the total number of tags associated with the current image to create a discrete probability distribution over the finite tag vocabulary for each multimedia object. Next, to model the probability distributions in the input layer, use soft-max as the visible units in the first level RBM while its hidden units and also all other units in the deep network are chosen binary. However, the output units at the top level of the network are linear. The multi-class cross-entropy error function may be used to refine the weights and biases in the back-propagation algorithm.

In particular embodiments, once the deep network is trained, derive a low-dimensional representation of each of the multimedia objects in the semantic space by applying the learned model to each multimedia object and use its top-level unit values as its low-dimensional description. Note that in particular embodiments, the mapping from the word count vector, i.e. the basic tag description, to a high level semantic feature only consists of a single matrix multiplication and single squashing function per network unit.

In particular embodiments, having computed the feature values for each of the individual multimedia objects belonging to a set of multimedia objects, non-parametric density estimation may be performed to derive the probabilities of the individual features denoted by P(fᵢ^{j}). A one-dimensional probability density for each of the feature values may be computed using Parzen's windows, as discussed in more detail in Pattern Classification, 2nd Edition, by R. O. Duda, P. E. Hart, and D. G. Stock. For each feature value, a Gaussian kernel may be used and 10-fold cross validation may be performed to find the best kernel width. The goal is to build a model of the data that accurately reflects the underlying probability distribution. This goal may be achieved by finding the kernel variance that provides a model that best predicts, that is, gives the highest probability, for the held-out test data. The distributions are often bimodal or skewed. The product of these distributions is a model of multimedia object likelihood as a function of the multimedia objects. The distributions are a model of the visual, semantic, and other metadata feature values that are computed. More specifically, each feature dimension may be treated as a separate feature and its probability may be calculated separately. The individual feature probabilities in Equation (2) are thus calculated separately.

In particular embodiments, the statistical sub-models employed to calculate the probabilities for the individual feature values may be trained to improve the performance and the results of the statistical sub-models. Training a statistical sub-model generally refers to the process of repeatedly generating multiple versions of the statistical sub-model using multiple sets of test inputs so that the version or versions of the statistical sub-model that provide the best or better results may be selected and used. In this case, each set of test inputs may be a set of multimedia objects identified in response to a search query. The search may be conducted in any suitable manner, such as an Internet search, a database search, etc. Alternatively or in addition, control test sets, e.g., test sets defined by human researchers or developers, may be used for training purposes as well. Some or all of the steps in FIG. 2 may be repeated multiple times for multiple sets of multimedia objects.

In particular embodiments, to avoid biasing the training of the statistical sub-models, within each set of multimedia objects used to train a statistical sub-model, the multimedia objects may be filtered. For example, suppose a set of multimedia objects used for training a particular statistical sub-model is in response to a search query requesting images of the Golden Gate Bridge in San Francisco, Calif. The set of multimedia objects, in this case, most likely includes photographs of the Golden Gate Bridge taken by various users and posted on the Internet. If for some reason a particular user has taken and posted thousands of photographs of the Golden Gate Bridge on the Internet, much more than the number of photographs posted by most of the other users, the set of multimedia objects is likely to include many more photographs from this particular user than from the other users. Used as it is to train the statistical sub-model, the statistical sub-model is likely to be biased toward this single user. To avoid such bias, only one photograph of the Golden Gate Bridge from each user may be selected for the training set.

Once the probabilities of the individual multimedia objects belonging to the set of multimedia objects are calculated, the multimedia objects are ranked based on their corresponding probabilities (step 260). A multimedia object with a relatively higher probability is ranked relatively higher. Conversely, a multimedia object with a relatively lower probability is ranked relatively lower.

The multimedia objects may then be presented to the user requesting the search according to their ranks (step 270). In particular embodiments, all of the multimedia objects from the set are included in the search results generated for the search query. In particular embodiment, only a subset of the multimedia objects, e.g., the top 75% ranked objects or the top 50% ranked objects, from the set are included in the search results generated for the search query. The lowest ranked multimedia objects may be discarded as they are not too representative and thus less relevant to the search query. The selected multimedia objects may be presented to the user requesting the search in a suitable user interface, e.g., as a web page or a computer display containing the multimedia objects, with the relatively higher ranked multimedia objects presented before the relatively lower ranked multimedia objects.

The method described above may be implemented as computer software using computer-readable instructions and physically stored in computer-readable medium. A “computer-readable medium” as used herein may be any medium that can contain, store, communicate, propagate, or transport the program for use by or in connection with the instruction execution system, apparatus, system or device. The computer readable medium may be, by way of example only but not by limitation, an electronic, magnetic, optical, electromagnetic, infrared, or semiconductor system, apparatus, system, device, propagation medium, or computer memory.

The computer software may be encoded using any suitable computer languages, including future programming languages. Different programming techniques can be employed, such as, for example, procedural or object oriented. The software instructions may be executed on various types of computers, including single or multiple processor devices.

Embodiments of the present disclosure may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of the present disclosure can be achieved by any means as is known in the art. Distributed or networked systems, components and circuits may be used. Communication, or transfer, of data may be wired, wireless, or by any other means.

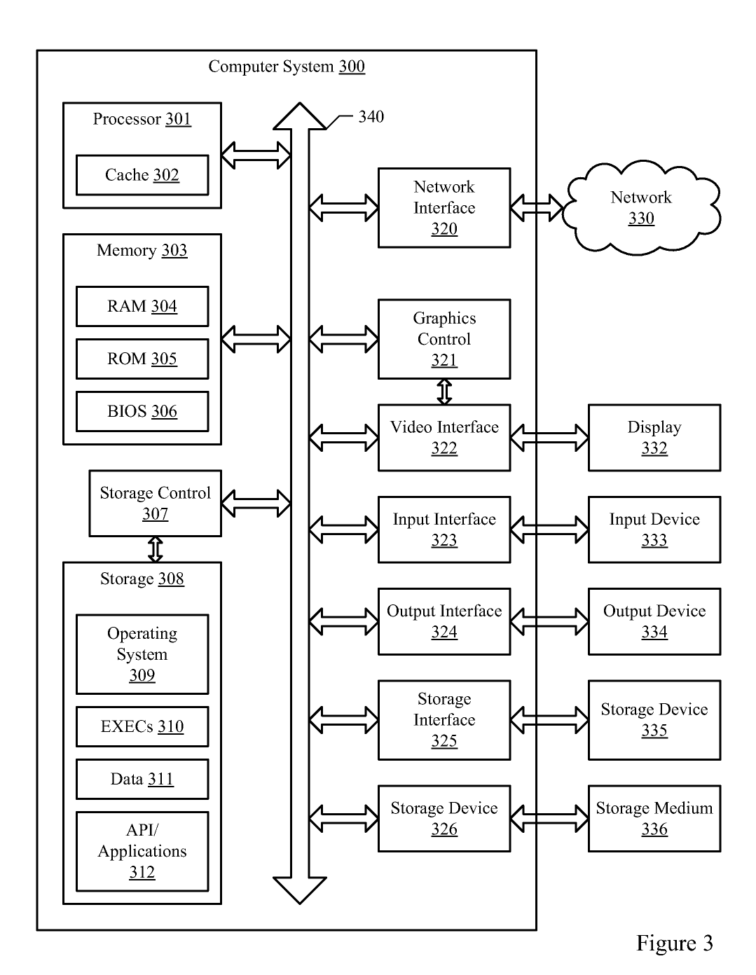

For example, FIG. 3 illustrates an example computer system 300 suitable for implementing embodiments of the present disclosure. The components shown in FIG. 3 for computer system 300 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 300 may have many physical forms including an integrated circuit, a printed circuit board, a small handheld device (such as a mobile telephone or PDA), a personal computer or a super computer.

Computer system 300 includes a display 332, one or more input devices 333 (e.g., keypad, keyboard, mouse, stylus, etc.), one or more output devices 334 (e.g., speaker), one or more storage devices 335, various types of storage medium 336.

The system bus 340 link a wide variety of subsystems. As understood by those skilled in the art, a “bus” refers to a plurality of digital signal lines serving a common function. The system bus 340 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 301 (also referred to as central processing units, or CPUs) optionally contain a cache memory unit 302 for temporary local storage of instructions, data, or computer addresses. Processor(s) 301 are coupled to storage devices including memory 303. Memory 303 includes random access memory (RAM) 304 and read-only memory (ROM) 305. As is well known in the art, ROM 305 acts to transfer data and instructions uni-directionally to the processor(s) 301, and RAM 304 is used typically to transfer data and instructions in a bi-directional manner. Both of these types of memories may include any suitable of the computer-readable media described below.

A fixed storage 308 is also coupled bi-directionally to the processor(s) 301, optionally via a storage control unit 307. It provides additional data storage capacity and may also include any of the computer-readable media described below. Storage 308 may be used to store operating system 309, EXECs 310, application programs 312, data 311 and the like and is typically a secondary storage medium (such as a hard disk) that is slower than primary storage. It should be appreciated that the information retained within storage 308, may, in appropriate cases, be incorporated in standard fashion as virtual memory in memory 303.

Processor(s) 301 is also coupled to a variety of interfaces such as graphics control 321, video interface 322, input interface 323, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 301 may be coupled to another computer or telecommunications network 330 using network interface 320. With such a network interface 320, it is contemplated that the CPU 301 might receive information from the network 330, or might output information to the network in the course of performing the above-described method steps. Furthermore, method embodiments of the present disclosure may execute solely upon CPU 301 or may execute over a network 330 such as the Internet in conjunction with a remote CPU 301 that shares a portion of the processing.

According to various embodiments, when in a network environment, i.e., when computer system 300 is connected to network 330, computer system 300 may communicate with other devices that are also connected to network 330. Communications may be sent to and from computer system 300 via network interface 320. For example, incoming communications, such as a request or a response from another device, in the form of one or more packets, may be received from network 330 at network interface 320 and stored in selected sections in memory 303 for processing. Outgoing communications, such as a request or a response to another device, again in the form of one or more packets, may also be stored in selected sections in memory 303 and sent out to network 330 at network interface 320. Processor(s) 301 may access these communication packets stored in memory 303 for processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 300 may provide functionality as a result of processor(s) 301 executing software embodied in one or more tangible, computer-readable media, such as memory 303. The software implementing various embodiments of the present disclosure may be stored in memory 303 and executed by processor(s) 301. A computer-readable medium may include one or more memory devices, according to particular needs. Memory 303 may read the software from one or more other computer-readable media, such as mass storage device(s) 335 or from one or more other sources via communication interface. The software may cause processor(s) 301 to execute particular processes or particular steps of particular processes described herein, including defining data structures stored in memory 303 and modifying such data structures according to the processes defined by the software. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

A “processor”, “process”, or “act” includes any human, hardware or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time”, “offline”, in a “batch mode”, etc. Portions of processing can be performed at different times and at different locations, by different (or the same) processing systems.

Although the acts, operations or computations disclosed herein may be presented in a specific order, this order may be changed in different embodiments. In addition, the various acts disclosed herein may be repeated one or more times using any suitable order. In some embodiments, multiple acts described as sequential in this disclosure can be performed at the same time. The sequence of operations described herein can be interrupted, suspended, or otherwise controlled by another process, such as an operating system, kernel, etc. The acts can operate in an operating system environment or as stand-alone routines occupying all, or a substantial part, of the system processing.

Reference throughout the present disclosure to “particular embodiment”, “example embodiment”, “illustrated embodiment”, “some embodiments”, “various embodiments”, “one embodiment”, or “an embodiment” means that a particular feature, structure, or characteristic described in connection with the embodiment is included in at least one embodiment of the present disclosure and not necessarily in all embodiments. Thus, respective appearances of the phrases “in a particular embodiment”, “in one embodiment”, “in some embodiments”, or “in various embodiments” in various places throughout this specification are not necessarily referring to the same embodiment. Furthermore, the particular features, structures, or characteristics of any specific embodiment of the present disclosure may be combined in any suitable manner with one or more other embodiments. It is to be understood that other variations and modifications of the embodiments of the present disclosure described and illustrated herein are possible in light of the teachings herein and are to be considered as part of the spirit and scope of the present disclosure.

It will also be appreciated that one or more of the elements depicted in FIGS. 1 through 3 can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Additionally, the term “or” as used herein is generally intended to mean “and/or” unless otherwise indicated. Combinations of components or steps will also be considered as being noted, where terminology is foreseen as rendering the ability to separate or combine is unclear.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
constructing by one or more computer systems a statistical model for a plurality of multimedia objects identified in response to a search query, the statistical model comprising a plurality of probabilities, wherein:
each of the multimedia objects uniquely corresponding to a different one of a plurality of sets of feature values,
each of the feature values of each of the sets of feature values being a characterization of the multimedia object corresponding to the set of feature values, and
each of the probabilities being calculated for a different one of the multimedia objects based on the set of feature values corresponding to the multimedia object; and
ranking the multimedia objects based on their corresponding probabilities, such that a multimedia object having a relatively higher probability is ranked relatively higher.

2. The method as recited in claim 1, wherein for each of the multimedia objects and its corresponding set of feature values, each feature value of the set of feature values uniquely corresponds to a different one of a set of features and has a value that characterizes the corresponding multimedia object with respect to its corresponding feature.

3. The method as recited in claim 2, wherein the set of features comprises one or more audio features, one or more visual features, one or more textual features, one or more geographic features, or one or more temporal features.

4. The method as recited in claim 1, wherein each of the probabilities is calculated for its corresponding multimedia object based on the set of feature values corresponding to the multimedia object as:
P(O)=P(f₁, . . . , fₙ)
where O denotes the corresponding multimedia object, f₁ . . . fₙ denotes the set of feature values corresponding to O, P(O) denotes the probability calculated for O, and P(f₁, . . . , fₙ) denotes a probability of f₁ . . . fₙ.

5. The method as recited in claim 4, wherein each of the probabilities is approximated as:
$$P ( O ) ∝ {\prod }_{i = 1}^{i = n} {[ P ( {f}_{i} ) ]}^{{α}_{i}}$$
where O denotes the corresponding multimedia object, fᵢ denotes a particular feature value of the set of feature values corresponding to O, P(O) denotes the probability calculated for O, P(fᵢ) denotes a probability of fᵢ, and αᵢ denotes a weight assigned to P(fᵢ).

6. The method as recited in claim 5, wherein for each of the multimedia objects and its corresponding set of feature values, the set of feature values comprises a first feature value and a second feature value, a first statistical sub-model is used to calculate the probability of the first feature value, and a second statistical sub-model is used to calculate the probability of the second feature value.

7. The method as recited in claim 6, further comprising pre-training the first statistical sub-model.

8. The method as recited in claim 6, wherein for each of the multimedia objects and its corresponding set of feature values, the first feature value is a visual feature value, and the first statistical sub-model is locally shift-invariant, sparse representations.

9. The method as recited in claim 6, wherein for each of the multimedia objects and its corresponding set of feature values, the second feature value is a textual feature value, and the second statistical sub-model is a combination of word and content description.

10. The method as recited in claim 1, further comprising:
generating a search result for the search query, the search result comprising one or more of the multimedia objects ordered based on their corresponding ranks, wherein between a first one of the multimedia objects having a first rank and a second one of the multimedia objects having a second rank, the first multimedia object is placed before the second multimedia object in the search result if the first rank is greater than the second rank; and
presenting the search result to a user requesting the search query based on their ranks.

11. The method as recited in claim 10, further comprising displaying the search result for the user.

12. An apparatus comprising:
a memory comprising instructions executable by one or more processors; and
one or more processors coupled to the memory and operable to execute the instructions, the one or more processors being operable when executing the instructions to:
construct a statistical model for a plurality of multimedia objects identified in a search result generated in response to a search query by a search engine, the statistical model comprising a plurality of probabilities, wherein:
each of the multimedia objects uniquely corresponding to a different one of a plurality of sets of feature values,
each of the feature values of each of the sets of feature values being a characterization of the multimedia object corresponding to the set of feature values, and
each of the probabilities being calculated for a different one of the multimedia objects based on the set of feature values corresponding to the multimedia object; and
rank the multimedia objects based on their corresponding probabilities, such
that a multimedia object having a relatively higher probability is ranked relatively higher.

13. The apparatus as recited in claim 12, wherein for each of the multimedia objects and its corresponding set of feature values, each feature value of the set of feature values uniquely corresponds to a different one of a set of features and has a value that characterizes the corresponding multimedia object with respect to its corresponding feature.

14. The apparatus as recited in claim 13, wherein the set of features comprises one or more audio features, one or more visual features, one or more textual features, one or more geographic features, or one or more temporal features.

15. The apparatus as recited in claim 12, wherein each of the probabilities is calculated for its corresponding multimedia object based on the set of feature values corresponding to the multimedia object as:
P(O)=P(f₁, . . . , fₙ)
where O denotes the corresponding multimedia object, f₁ . . . fₙ denotes the set of feature values corresponding to O, P(O) denotes the probability calculated for O, and P(f₁, . . . , fₙ) denotes a probability of f₁ . . . fₙ.

16. The apparatus as recited in claim 15, wherein each of the probabilities is approximated as:
$$P ( O ) ∝ {\prod }_{i = 1}^{i = n} {[ P ( {f}_{i} ) ]}^{{α}_{i}}$$
where O denotes the corresponding multimedia object, fᵢ denotes a particular feature value of the set of feature values corresponding to O, P(O) denotes the probability calculated for O, P(fᵢ) denotes a probability of fᵢ, and αᵢ denotes a weight assigned to P(fᵢ).

17. The apparatus as recited in claim 16, wherein for each of the multimedia objects and its corresponding set of feature values, the set of feature values comprises a first feature value and a second feature value, a first statistical sub-model is used to calculate the probability of the first feature value, and a second statistical sub-model is used to calculate the probability of the second feature value.

18. The apparatus as recited in claim 17, wherein for each of the multimedia objects and its corresponding set of feature values:
the first feature value is a visual feature value,
the first statistical sub-model is locally shift-invariant, sparse representations.
the second feature value is a textual feature value, and
the second statistical sub-model is a combination of word and content description.

19. The apparatus as recited in claim 12, wherein the one or more processors are further operable when executing the instructions to:
generate a search result for the search query, the search result comprising one or more of the multimedia objects ordered based on their corresponding ranks, wherein between a first one of the multimedia objects having a first rank and a second one of the multimedia objects having a second rank, the first multimedia object is placed before the second multimedia object in the search result if the first rank is greater than the second rank; and
present the search result to a user requesting the search query based on their ranks.

20. One or more computer-readable storage media embodying software operable when executed by one or more computer systems to:
construct a statistical model for a plurality of multimedia objects identified in response to a search query, the statistical model comprising a plurality of probabilities, wherein:
each of the multimedia objects uniquely corresponding to a different one of a plurality of sets of feature values,
each of the feature values of each of the sets of feature values being a characterization of the multimedia object corresponding to the set of feature values, and
each of the probabilities being calculated for a different one of the multimedia objects based on the set of feature values corresponding to the multimedia object; and
rank the multimedia objects based on their corresponding probabilities, such that a multimedia object having a relatively higher probability is ranked relatively higher.

21. The media as recited in claim 20, wherein for each of the multimedia objects and its corresponding set of feature values, each feature value of the set of feature values uniquely corresponds to a different one of a set of features and has a value that characterizes the corresponding multimedia object with respect to its corresponding feature.

22. The media as recited in claim 21, wherein the set of features comprises one or more audio features, one or more visual features, one or more textual features, one or more geographic features, or one or more temporal features.

23. The media as recited in claim 20, wherein each of the probabilities is calculated for its corresponding multimedia object based on the set of feature values corresponding to the multimedia object as:
P(O)=P(f₁, . . . , fₙ)
where O denotes the corresponding multimedia object, f₁ . . . fₙ denotes the set of feature values corresponding to O, P(O) denotes the probability calculated for O, and P(f₁, . . . , fₙ) denotes a probability of f₁ . . . fₙ.

24. The media as recited in claim 23, wherein each of the probabilities is approximated as:
$$P ( O ) ∝ {\prod }_{i = 1}^{i = n} {[ P ( {f}_{i} ) ]}^{{α}_{i}}$$
where O denotes the corresponding multimedia object, fᵢ denotes a particular feature value of the set of feature values corresponding to O, P(O) denotes the probability calculated for O, P(fᵢ) denotes a probability of fᵢ, and αᵢ denotes a weight assigned to P(fᵢ).

25. The media as recited in claim 24, wherein for each of the multimedia objects and its corresponding set of feature values, the set of feature values comprises a first feature value and a second feature value, a first statistical sub-model is used to calculate the probability of the first feature value, and a second statistical sub-model is used to calculate the probability of the second feature value.

26. The media as recited in claim 25, wherein for each of the multimedia objects and its corresponding set of feature values:
the first feature value is a visual feature value,
the first statistical sub-model is locally shift-invariant, sparse representations.
the second feature value is a textual feature value, and
the second statistical sub-model is a combination of word and content description.

27. The media as recited in claim 20, wherein the software is further operable when executed by one or more computer systems to:
generate a search result for the search query, the search result comprising one or more of the multimedia objects ordered based on their corresponding ranks, wherein between a first one of the multimedia objects having a first rank and a second one of the multimedia objects having a second rank, the first multimedia object is placed before the second multimedia object in the search result if the first rank is greater than the second rank; and
present the search result to a user requesting the search query based on their ranks.
